(19) United States
(12) Patent Application Publication
(10) Pub. No.: US 2004/0181923 A1
(43) Pub. Date: Sep. 23, 2004

(54) Process for reusing and recycling circuit boards

(76) Inventor: James Carl Dills, Monument, CO (US)

Correspondence Address: LAW OFFICE OF DALE B. HALLING, 24 s. WEBER ST., SUITE 311, COLORADO SPRINGS, CO, 80903, US

(21) Appl. No.: 10/800,937

(22) Filed: Mar. 15, 2004

Related U.S. Application Data
(60) Provisional application No. 60/455,315, filed on Mar. 17, 2003.

(51) Int. Cl. H02G 1/12

(52) U.S. Cl. 29/403.3

(57) ABSTRACT

A process for reusing circuit boards includes determining a type of solder used on a populated circuit board. A bio-slurry designed to remove the type of solder is selected. The populated circuit board is separated into a number of components and a circuit board.

### RELATED APPLICATIONS

The present invention claims priority on provisional patent application Serial No. 60/455,315, filed on Mar. 17, 2002, entitled “Biochemical Process for the Separation of Toxic Substances, Including Heavy Metals Contained in Integrated Circuit Boards”.

### FIELD OF THE INVENTION

The present invention relates generally to the field of recycling and more particularly to a process for reusing and recycling circuit boards.

### BACKGROUND OF THE INVENTION

The fast pace of product life cycles in the electronics and computer industry results in large amounts of obsolete electronic products. These electronic products represent a landfill problem. These products often have heavy metals that can seep into ground water and contaminate water supplies. Recent legislation in Europe, China and several US states now mandate that in the near future electronics' manufactures must to take back their products at the end of the products life. In addition, the stringent rules of many landfills no longer allow these products to be thrown away. One of the main problems in recycling electrical and electronics products is the circuit boards. The circuit boards and their components have most of the heavy metals and may contain lead, mercury, cadmium and chromium. All of which are being strictly regulated. Presently, the only way to separate and extract these metals is to expose the circuit board to high temperatures until the metals vaporize and then the specific heavy metal can be separated and recovered. Unfortunately, this process is expensive, requires a tremendous amount of energy and introduces toxic off gasses into the atmosphere.

Thus there exists a need for a process for recycling and reusing circuit boards and the components attached to the circuit boards.

### SUMMARY OF INVENTION

A process for reusing circuit boards includes determining a type of solder used on a populated circuit board. A bio-slurry designed to remove the type of solder is selected. The populated circuit board is separated into a number of components and a circuit board. Next the components may be separated into a first group of reusable components and a second group of recyclable components. A portion of the second group of recyclable components is pulverized into pieces. The pieces are placed in a second bio-slurry to separate a metal. In one embodiment, the portion of the second group of recyclable components is selected based on a type of metal present. The first group of reusable components may be segregated into classes of components.

In one embodiment it is determined if the type of solder contains lead.

In another embodiment, water is separated from the bio-slurry to form a sludge. A metal is separated from the sludge.

In one embodiment, a process for recycling circuit boards includes selecting a bio-slurry to remove a solder of a populated circuit board. The populated circuit board is placed in the bio-slurry. The populated circuit board is separated into components and a circuit board. The circuit board may be pulverized into pieces. The pieces are then placed in a second bio-slurry. In one embodiment, a type of solder used on the populated circuit board is identified. In another embodiment, it is determined if the type of solder includes lead.

The bio-slurry may be selected based on the type of solder used in the circuit board.

In one embodiment the components are separated into groups. For each of the groups it is determined if any components therein contain lead. Any group of components that contain lead may be pulverized into pieces. The pieces may the be placed in a bio-slurry.

In one embodiment, a process of recycling circuit boards includes grinding a circuit board into pieces. The pieces are placed in a bio-slurry. Next a metal is extracted. In one embodiment, a level of lead content in a circuit board is determined. When the level of lead does not exceed a predetermined threshold, a first type of bio-slurry is selected. When the level of lead does exceed a threshold, a second type of bio-slurry is selected. In one embodiment, a liquid is separated from the bio-slurry. The liquid may be processed to have a non-contaminated water.

### BRIEF DESCRIPTION OF THE DRAWINGS

FIG. 1 is a drawing of a populated circuit board in accordance with one embodiment of the invention;

FIG. 2 is a flow chart of a process for separating reusing a circuit board in accordance with one embodiment of the invention; and

FIG. 3 is a flow chart of a process for separating and recycling a circuit board in accordance with one embodiment of the invention.

### DETAILED DESCRIPTION OF THE DRAWINGS

A process for recycling and reusing circuit boards uses the power of a number of bio-organisms that have been developed to reduce the cost and energy required for this process. There are numerous patents and papers that deal with how bio-organisms may be used to remove heavy metals and other materials from soil or ores. This patent takes advantage of these bio-organisms and is directed to exploiting these bio-organisms to solve the pressing need to separate, recycle or reuse circuit boards.

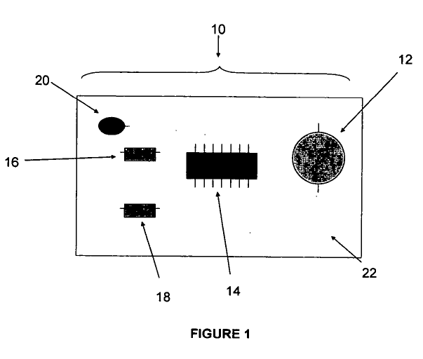

FIG. 1 is a drawing of a populated circuit board 10 in accordance with one embodiment of the invention. The populated circuit board 10 has a number of components 12, 14, 16, 18, 20 soldered to a circuit board 22. The components 12, 14, 16, 18, 20 may range from resistors to complex integrated circuits. The components may be reusable, if they can be economically removed from the circuit board 22. The circuit board 22 is almost never reusable, as the traces of metal that connect the components are often highly specific to the particular design of that circuit board. Both the components 12-20 and the circuit board 22 contain metals.

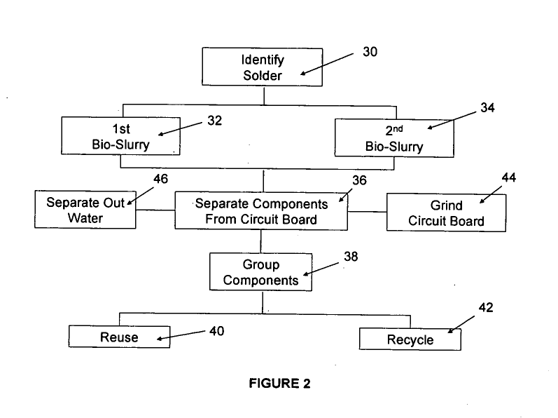

FIG. 2 is a flow chart of a process for separating and reusing a circuit board in accordance with one embodiment of the invention. The process starts by identifying a type of solder used. Historically, solders are made mainly of lead. This is a highly toxic substance. New solders are being developed that use very little or almost no lead. If the solder used on the populated circuit board contains lead it requires a different process than the new types of solder. When the solder has lead the circuit board is placed in a first bio-slurry. A bio-slurry includes microorganisms that are designed to attack a particular type or types of metal and the various environmental conditions required for these microorganisms to thrive. For instance, one type of microorganism requires sulfur in the right quantities to attack a metal. The microorganisms can attack the metals in a variety of ways. In one case the microorganisms produce an acid that dissolves the metal. In another case the microorganisms ingest or bind to the metals. Based on the type of metals in the solder, the populated circuit board is placed in either a first bio-slurry 32 or a second bio-slurry 34. As the number of solders increase and as the microorganisms used become more specific in the metal they attack the number of possible bio-slurries may increase beyond two. Next, as a result of the microorganism attacks, the components are separated from the circuit board at step 36. This is made possible by having the bio-slurry preferentially attack the solder over other metals. The separation in one embodiment involves vibrating the circuit board. In another embodiment, the components may be scrapped off of the circuit board. Other methods may also be used. The components are then separated into groups at step 38. In one embodiment this is done by shaking and sieve system. Ideally, the components are completely separated into the different models, however this may not always be necessary. Those components that may be reused are separated at step 40. Examples may include certain resistors, capacitors and even some general purpose integrated circuits. For instance, slower clock speed microprocessors may have utility in application specific electronics, such as microwave oven controllers. Those components that cannot be reused are recycled at step 42. In one embodiment, the components are recycled by pulverizing or grinding the components into small pieces. The pieces are placed in another bio-slurry to extract various metals. Note this could be one bio-slurry process or several bio-slurry steps.

Once the components have been separated from the circuit board, the circuit board is pulverized into a number of pieces at step 44. The pieces are placed in a bio-slurry to extract any metal.

After any of the bio-slurries have been used the water is separated out of the slurry at step 46. In one embodiment, the microorganisms may be extracted from the bio-slurry. Once the organisms are extracted they may be reused or they may be processed to extract any stray metals. This may include a vaporization process or process similar to that used to extract metals from contaminated soil. In one embodiment, the water may be purified by techniques such as reverse osmosis. The left over materials may be processed by techniques similar to those used to extract metals from contaminated soils.

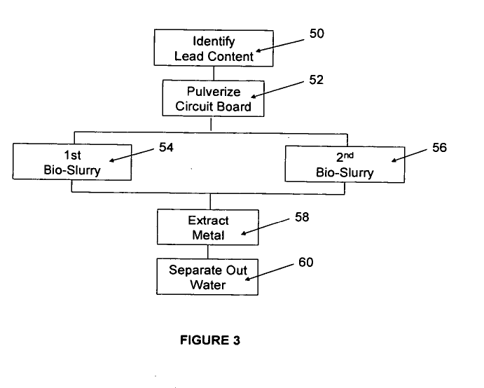

FIG. 3 is a flow chart of a process for recycling a circuit board in accordance with one embodiment of the invention. The process starts at step 50 by identifying a lead content in the solder. In the alternative, because of various regulations it may be necessary to determine the lead content of the populated circuit board or the various components. These may require special handling under various regulations. The populated circuit board is pulverized at step 52. This may be accomplished by grinding the populated circuit board into a number of pieces. Then the pieces are placed in one of several bio-slurries 54, 56 based on the level of lead or other metals. The metal or metals are extracted at step 58 and the water is separated out of the bio-organisms at step 60. The water and left over materials may be processed in a manner similar to those discussed with respect to FIG. 2.

The bio-slurries discussed herein require very little power and may in fact generate excess heat energy. As a result, the processes described herein require very little energy and do not produce off gasses compared to prior art techniques. This makes this processes extremely energy efficient, reduces toxic off gasses in the atmosphere and is less expensive than the prior art techniques. In addition, some of the components may be reused in some embodiments and this substantially lowers the cost of recycling the populated circuit boards.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A process for reusing circuit boards, comprising:
a) determining a type of solder used on a populated circuit board;
b) selecting a bio-slurry designed to remove the type of solder; and
c) separating the populated circuit board into a plurality of components and a circuit board.

2. The process of claim 1, further including the steps of:
d) separating the plurality of components into a first group of reusable components and a second group of recyclable components.

3. The process of claim 2, further including the steps of:
e) pulverizing at least a portion of the second group of recyclable components into a plurality of pieces; and
f) placing the pieces in a second bio-slurry to separate a metal.

4. The process of claim 3, wherein step (e) includes the step of:
e1) selecting the at least the portion of the second group of recyclable components, based on a type of metal present.

5. The process of claim 2, further including the steps of:
e) segregating the first group of reusable components into a plurality of classes of components.

6. The process of claim 1, wherein step (a) further includes the step of:
a1) determining if the type of solder contains lead.

7. The process of claim 1, further including the step of:
d) separating a water from the bio-slurry to form a sludge;
e) separating a metal from the sludge.

8. A process for recycling circuit boards, comprising the steps of;
a) selecting a bio-slurry to remove a solder of a populated circuit board;
b) immersing the populated circuit board in the bio-slurry; and
c) separating the populated circuit board into a plurality of components and a circuit board.

9. The process of claim 8, further including the step of:
d) pulverizing the circuit board into a plurality of pieces;
e) placing the plurality of pieces in a second bio-slurry.

10. The process of claim 8, wherein step (a) further includes the step of:
a1) identifying a type of solder used on the populated circuit board.

11. The process of claim 10, wherein step (a1) further includes the step of determining if the type of solder includes lead.

12. The process of claim 10, further including the step of:
a2) selecting the bio-slurry based on the type of solder.

13. The process of claim 8, further including the step of:
d) separating the plurality of components into groups.

14. The process of claim 13, further including the step of:
e) determining for each of the groups if any components therein contain lead.

15. The process of claim 14, further including the step of:
f) pulverizing any group of components that contain lead to form a plurality of pieces;
g) placing the plurality of pieces in a bio-slurry.

16. A process of recycling circuit boards, comprising the steps of:
a) grinding a circuit board into a plurality of pieces;
b) placing the plurality of pieces in a bio-slurry; and
c) extracting a metal.

17. The process of claim 16, wherein step (a) further includes the step of:
a1) determining a level of lead content in a circuit board;
a2) when the level of lead does not exceed a predetermined threshold, selecting a first type of bio-slurry.

18. The process of claim 17, further including the step of:
a3) when the level of lead does exceed a predetermined threshold, selecting a second type of bio-slurry.

19. The process of claim 16, further including the step of:
d) removing a liquid from the bio-slurry;

20. the process of claim 19, further including the step of:
e) processing the liquid to have a non-contaminated water.
